(19) United States
(12) Patent Application Publication
(10) Pub. No.: US 2007/0291920 A1
(43) Pub. Date: Dec. 20, 2007

(54) Prompted Sending of Information by a Telephone Terminal

(75) Inventor: Marian Jaworski, Trinec (CZ)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AG OSTERREICH, WIEN AUSTRIA (AU)

(21) Appl. No.: 10/571,498

(22) PCT Filed: Sep. 10, 2004
(86) PCT No.: PCT/EP04/10101

§ 371 Date: Mar. 22, 2007

(30) Foreign Application Priority Data
Sep. 11, 2003 (AT) A1439/2003

(51) Int. Cl. H04Q 7/22; H04M 7/16

(52) U.S. Cl. 379/229

(57) ABSTRACT

The invention relates to a method for the prompted sending of information by a terminal in a telephone network, comprising the following steps: a) receipt of a first message signaling a connection request for the terminal in a connection-oriented service of the telephone network, b) rejection of the connection request, c) determination of the information to be sent, d) sending of a response message generated from said information using a connectionless service of a telecommunications network.

### CROSS REFERENCE TO RELATED APPLICATION

This application is the US National Stage of International Application No. PCT/EP2004/010101, filed Sep. 10, 2004 and claims the benefit thereof. The International Application claims the benefits of Austrian Patent application No. A1439/2003 AT filed Sep. 11, 2003, both of the applications are incorporated by reference herein in their entirety.

### FIELD OF THE INVENTION

The invention relates to a method for the prompted sending of information by a terminal station in a telephone network.

### BACKGROUND OF THE INVENTION

The interrogation of information by a terminal is necessary in conjunction with many applications, e.g. if the current position (in particular GPS position) of a mobile device is requested by a management system of a vehicle fleet, the version of a software installed on the device, the local ambient temperature or the charging state of the terminal accumulator. As these examples indicate, these often concern changeable status data of the terminal, not linked to or not directly linked to the telephone service, or environmental data at the location of the terminal.

Known solutions for interrogating data of this type use a short message for instance (in the GSM network e.g. SMS messages) as a prompt to the terminal to send the desired information, which is sent for instance in a reply short message. Another known alternative consists in establishing a telephone connection with the terminal station starting from the requesting station, wherein the request and the interrogated information are exchanged. These known solutions are disadvantageous in that a chargeable request is initiated starting from the interrogating station. In addition, with the solution which uses a telephone, a connection is additionally busy for the duration of the information exchange.

### SUMMARY OF THE INVENTION

The object underlying the present invention is thus to create a means to trigger the transmission of information by the terminal station in the most simple, cost-effective and thus reliable way possible.

The addressed object is achieved by a method of the type mentioned at the beginning, in which the following steps are carried out by the terminal station in accordance with the invention:

Receipt of a first message signaling a connection request for the terminal in a connection-oriented, service of the telephone network,

Rejection of the connection request,

Determination of the information to be sent

Sending of a response message generated from said information using a connectionless service of a telecommunications network.

This solution according to the invention thus provides for the use of a connection call as a transmit prompt and fulfils the addressed object in a simple manner. As the positioning of a connection call is a charge-free facility of the telephone network, no charges are incurred and no resources of the network or of the terminal are additionally connected.

In a preferred embodiment of the invention, a distinction is made between a transmit prompt according to the invention and a ‘conventional’ call request by means of the call number of the interrogating station, which is sent in modern networks in the message indicating the call request. In this case, subsequent to a) a transmitter address contained in the first message is evaluated to determine whether this corresponds with the transmitter address of a network or subscriber station, the address of which is stored by the terminal, if this is the case, the further steps are executed from step b), or else the connection request is handled according to a known manner.

The information specific to a transmit prompt can also be contained in the message of the connection call in another manner, for example encoded in an additional field of the message or as a PBX suffix of the transmitter address. In this case, subsequent to step a) a transmitter address contained in the first message and/or further message data can be evaluated to determine whether these contain specific information for a prompt to transmit a response message; if this is the case, the further steps are executed from step b), or else the call request is handled according to a known manner.

The type of information to be transmitted can hereby be determined on the basis of the specific information. In this way, the interrogating station can intentionally select the desired information from a set of provided data.

The telephone network itself can be used in an advantageous variant as the telecommunication network used in step d).

A computer program with program code means is particularly suited to implementing the invention, in order to carry out the method according to the invention, when the program is executed on a terminal station of a telephone network. A computer program product with program code means, which are stored on a machine-readable data medium, is similarly suited to implementing the method according to the invention, if the program is executed on a terminal station of a telephone network.

Said object is likewise achieved by a telephone terminal, which is set up to implement said method according to the invention, and is achieved, in particular, by a telephone terminal with program code means, which are stored on a memory assigned to the terminal in order to implement the method according to the invention when the program is executed on the terminal.

### BRIEF DESCRIPTION OF THE DRAWINGS

The invention together with further advantages is described in further detail below with reference to an unrestrictive exemplary embodiment displayed in the appended drawings, in which;

FIG. 1 shows a diagrammatic representation of the components participating in the exemplary embodiment;

FIG. 2 shows a signal flow diagram of a prompted sending sequence according to the invention

### DETAILED DESCRIPTION OF THE INVENTION

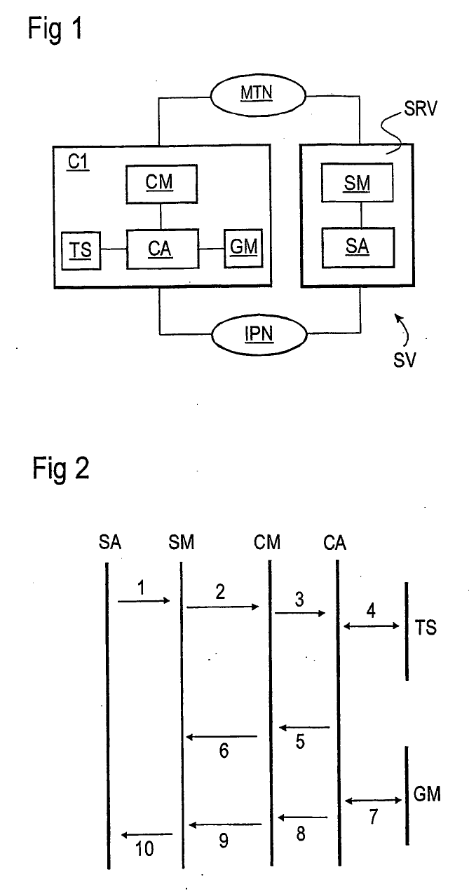

In this exemplary embodiment, the central office of a transportation company requests to determine the location of a van in the vehicle fleet. To be able to perform an enquiry of this type within the scope of the location management SV, according to FIG. 1 a server device SRV of the central office is equipped with a modem SM of a known type, which is controlled via an application program SA. The van, like all other vehicles in the vehicle fleet, is equipped with a device C1, the modem CM of which is able to compare and identify incoming call numbers with those call numbers stored in a data base TS, via an application program CA. Likewise, the device C1 is able to extract the requested data from an assigned GPS module GM and transmit it to the server device SRV. The automatic data transmission can be carried out via the telephone network MTN or via an alternative data transfer system, such as the internet IPN.

FIG. 2 shows a typical signal exchange in the system in FIG. 1. In the signal flow diagram, the time passes vertically top down, the participating entities are symbolized using vertical lines and the messages exchanged between them as arrows. Since the transmission of the messages in the networks MTN, IPN takes place transparently according to a known manner, these networks and their network positions are suppressed in FIG. 2 for improved clarification purposes.

The application program SA of the server device SRV sends a command 1 for a data request to the modem SM. This sends a message 2, using the call number stored for the location interrogation, said message 2 being routed as a connection request, via the telephone network MTN, to the modem CM in the device C1. After registering 3 the call number and identifying it 4 as a location interrogation, the rejection 5, 6 of the call is carried out by the modem CM according to a known manner. After interrogating 7 the data of the assigned GPS module GM, said data is transmitted to the modem SM as a response message 8,9. After receipt 10 of the location data, said data is stored in the server device SRV of the central office.

This exemplary embodiment only represents one of the many possible embodiments of the invention. In fact, the invention can be used in any field of activity, if the following conditions are fulfilled;
The enquiring location and the terminal station are connected to at least one telecommunication system or data transfer system (GSM, TETRA, internet and the like).
In addition, the terminal station is equipped with a device which is able to provide the requested data. This data can be of any type, for instance temperature, location coordinates or humidity. This data is sent to the enquiring station via the above-mentioned connection (SMS, SDS, GPRS or e-mail for instance).

1-8. (canceled)

9. A method for the prompted sending of information by a terminal in a telephone network, comprising:
receipt of a first message signaling a connection request for the terminal in a connected-oriented service of the telephone network;
rejection of the connection request;
determination of the information to be sent; and
sending of a response message generated from said information using a connectionless service of a telecommunications network.

10. The method according to claim 9, wherein subsequent to the first step of the method, a transmitter address contained in the first message is evaluated to determine whether this corresponds with the transmitter address of a network or a subscriber station, the address of which is stored by the terminal, and the further steps are executed from the second step or the connection request is handled according to a known manner.

11. The method according to claim 9, wherein subsequent to the first step of the method a transmitter address contained in the first message and/or further message data is evaluated to determine whether this contains specific information for a prompt to send a response message, and the further steps are executed from the second step, or the connection request is handled according to the known manner.

12. The method according to claim 11, wherein the type of information to be transmitted is determined on the basis of the specific information.

13. The method according to claim 9, wherein the telephone network is used as the telecommunication network employed in the final step of the method.

14. The method according to claim 12, wherein a computer program with a program code to carry out the method is executed on a terminal station of a telephone network.

15. The method according to claim 12, wherein a computer program product with a program code is stored on a machine-readable data medium in order to carry out the method is executed on a terminal station of a telephone network.

16. The method according to claim 12, wherein a telephone terminal with a program code is stored on a memory assigned to the terminal to carry out the method if the program is executed on the terminal.
